(19) United States
(12) Patent Application Publication
(10) Pub. No.: US 2009/0314567 A1
(43) Pub. Date: Dec. 24, 2009

(54) Electric power tunnel apparatus

(76) Inventor: Mark Harrington, Los Alamitos, CA (US)

Correspondence Address: Mark Harrington, 11532 Donovan Road, Los Alamitos, CA, 90720, US

(21) Appl. No.: 12/214,719

(22) Filed: Jun. 20, 2008

(51) Int. Cl. B60K 25/10

(52) U.S. Cl. 180/165; 903/902

(57) ABSTRACT

An electric generator apparatus in the form of a self-contained module that can be attached to a vehicle and which is capable of generating electricity in response to movement of air through the module as the vehicle travels down the road. The electricity so generated may be used to power accessories on the vehicle or supplement the main engine in the vehicle. The module includes an inlet funnel or venturi, suitable rotating impellers or turbines responsive to the moving airstream therethrough, a suitable transmission or gearbox, a generator, and an electrical regulator or controller for delivering the electricity generated to a storage battery on the vehicle. Because of the relatively small size of each module, it can be placed anywhere on the vehicle and used in groupings or sets to increase the amount of electrical current produced.

### BACKGROUND OF THE INVENTION

1. Field of the Invention

The present invention relates generally to electric generating devices, and more particularly to self-contained wind-operable electrical generating devices especially useful on vehicles or the like.

2. Description of the Prior Art

Throughout the years, a number of innovations have been developed relating to the use of wind-operated electric generators mounted integrally on vehicle structures for the purpose of powering the vehicle, or supplementing the powering of the vehicle, after it comes up to a predetermined speed. The following U.S. patents are representative of some of those innovations: U.S. Pat. Nos. 4,632,205; 5,287,004; 5,917,304; 6,138,781; and 6,700,215.

More specifically, U.S. Pat. No. 4,632,205 teaches the use of a movable plate for creating a channel over a vehicle's windshield to direct air through a venturi at a fan motor which, in turn, drives a belt and a generator. The electricity generated is used to drive other components in the vehicle or is stored in a battery. U.S. Pat. No. 5,287,004 describes a vehicle having an airdam below the front fender and a spoiler on the top rear end thereof. Rotors and generators are integrated into each of these parts. In U.S. Pat. No. 5,917,304 a duct in the vehicle chassis is used to channel air into a fan in an electric vehicle for the purpose of generating electricity to charge the electric vehicle's batteries. U.S. Pat. No. 6,138,781 discloses the use of a multi-stage impeller and a compressor to generate electricity in a vehicle. Finally, U.S. Pat. No. 6,700,215 discloses a vehicle electric generation system comprises a plurality of different type generators mounted on different areas of the vehicle; one type being a wind-driven turbine and the other type being a rolling-wheel generator.

Thus, while many prior attempts have been made to harness the wind energy flowing over a moving car to improve efficiency, save fuel and lower the impact on the environment, these attempts have largely been unsuccessful primarily because major alterations to the structure of the vehicle are required thus increasing the cost of the vehicle beyond the fuel or efficiency savings achieved. In contrast, broadly stated, this invention provides a new and improved electric generator apparatus in the form of a replaceable self-contained module, requiring little or no modification or alteration to the vehicle.

Accordingly, while the foregoing body of referenced prior art indicates it to be well known to provide air-driven electric generators on various types of vehicles, the prior art described above does not teach or suggest an electric generating apparatus for use on vehicles or the like which has the following combination of desirable features: (1) provides a minimal alteration to the vehicle structure; (2) is simple in design and cost so as to be efficient to produce, install and operate; (3) operates in response to the movement of air resulting from motion of the vehicle; (4) is in the form of a replaceable, self-contained stand-alone module that is susceptible of being placed virtually anywhere on a vehicle either alone or in groupings of more than one module; (5) is in the form of a module having a wind tunnel inlet or venturi for increasing the efficiency of the air flowing therethrough; (6) is in the form of a module having rotating impellers or turbines and a generator for converting the flowing airstream therethrough into electrical current; (7) is in the form of a module which may be used to generate electricity in a conventional vehicle so that substantially all of the usual belts and pulleys that normally power auxiliary equipment may be removed from the vehicle's engine and the auxiliary equipment will driven by electric motors; (8) is in the form of a module which may be used on a gasoline or diesel vehicle to generate electricity to charge a battery on such vehicles, or to directly power auxiliary equipment in such vehicles; (9) is in the form of a module which may be used on a hybrid vehicle or on a pure electrical vehicle to generate electricity to charge a battery on such vehicles, or to directly power auxiliary equipment on such vehicles; (10) is in the form of a module which may be used on any vehicle type to generate electricity to charge a battery, or to directly power auxiliary equipment on such vehicles; or (11) is in the form of a module which may be used on any vehicle to generate electricity to charge a second or series of batteries on such vehicles, or to directly power auxiliary equipment on such vehicles. The foregoing desired characteristics are provided by the unique electric power tunnel apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a self-contained module that can be attached to a car or other vehicle and which is capable of generating electricity in response to movement of air through the module as the vehicle travels down the road. The electricity so generated is used to power accessories on the vehicle, supplement the main engine in the vehicle, or charge a battery in the vehicle. The module includes an inlet funnel or venturi, suitable rotating impellers or turbines responsive to the moving airstream therethrough, a suitable transmission or gearbox, a generator, and an electrical regulator or controller for managing and delivering the electricity generated to a storage battery on the vehicle. Because of the relatively small size of each module, they can be placed anywhere on the vehicle and used in groupings or sets of more than one module to increase the amount of electrical current produced.

The module according to the invention can be used on passenger vehicles, SUVs, trucks, buses, motorcycles, trailers, boats, stand-alone equipment or the like, or in a stand alone mode to power equipment. More specifically, when the module according to the invention is used on a vehicle having a gasoline or diesel engine, the module will replace the conventional generator and a second relatively large battery will be installed in the vehicle. The output of the module will be used to charge the second battery which, in turn, will be used to power the axillary equipment on the vehicle such as an air conditioner, a water pump, a power steering unit, and so on. Further, the second battery may power computers, monitors, refrigerators, modems, 110 voltage converters and other standard electrical home devices. This will permit removal of substantially all of the drive belts and pulleys normally used on the gasoline or diesel engine to power such auxiliary equipment. Similarly, when the module according to the present invention is used on a hybrid vehicle engine, the output of the module can be used to supplement charging of the hybrid vehicle's main battery thereby permitting use of a smaller more efficient engine. A second battery may also be added to a Hybrid vehicle allowing it to operate the electric motor(s) for longer durations, and both low and high speeds. Finally, when the module according to the present invention is used on a pure electric vehicle, a second battery will be installed on the vehicle and the module's output used to charge the second battery which in turn will charge the main battery or power auxiliary equipment. Throughout the ensuing specification, the module according to the present invention can be designated an “electric power tunnel” (or “EPT”).

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a number of preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in this art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved electric generating apparatus which has all of the advantages of the prior art and none of the disadvantages.

It is another object of the present invention to provide a new and improved electric generating apparatus which may be easily and efficiently manufactured and marketed.

It is a further object of the present invention to provide a new and improved electric generating apparatus which is of durable and reliable construction.

An even further object of the present invention is to provide a new and improved electric generating apparatus which is susceptible of a low cost of manufacture with regard to both materials and labor, and which accordingly is then susceptible of low prices of sale to the consuming public, thereby making such apparatus available to the buying public.

Still yet a further object of the present invention is to provide a new and improved electric generating apparatus which when used on a vehicle provides minimal alteration to the vehicle structure.

Still another object of the present invention is to provide a new and improved electric generating apparatus that is capable of operating in response to the movement of air resulting from motion of a vehicle.

Yet another object of the present invention is to provide a new and improved electric generator apparatus in the form of a replaceable self-contained module that is susceptible of being placed anywhere on a vehicle either alone or in groupings or sets of more than one module.

Even another object of the present invention is to provide a new and improved electric generator apparatus that is in the form of a module having a wind tunnel inlet or venturi for increasing the efficiency of the air flowing therethrough.

Yet another object of the present invention is to provide a new and improved electric generator apparatus which is in the form of a self-contained module having a wind tunnel inlet or venturi for increasing the efficiency of the air flowing therethrough and further contains rotating impellers or turbines and a generator for converting the flowing airstream therethrough into electrical current.

Still another object of the present invention is to provide a new and improved electric generator apparatus which is in the form of a self-contained module which may be used to generate electricity in a conventional vehicle (e.g. gasoline or diesel powered) so that the conventional generator or alternator and substantially all of the usual belts and pulleys that normally power auxiliary equipment normally used such vehicles may be dispensed with.

Yet another object of the present invention is to provide a new and improved electric generator apparatus is in the form of a module which may be used on a Hybrid vehicle or on a pure electrical vehicle to charge a battery on such vehicles, or to power auxiliary equipment on such vehicles.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is an elevational view showing a preferred embodiment of the electric generator apparatus of the invention in the form of a self-contained module or electric power tunnel (EPT).

FIG. 2 is a sectional view of the module or EPT of FIG. 1 taken along line 2-2 in FIG. 1 (i.e. essentially looking down from the top and showing the cover removed).

FIG. 3 is a schematic view of a turbine blade assembly mounted on a vertical rotation axis.

FIG. 4 is a schematic view of Darrieus-type rotatable turbine blade assembly.

FIG. 5 is a schematic view of a turbine blade assembly mounted on a horizontal rotation axis.

FIG. 6 is a schematic diagram of the electric power tunnel according to the present invention mounted on the hood of a passenger vehicle.

FIG. 7 is a schematic diagram of a pair of electric power tunnels according to the present invention mounted on or in the rear spoiler of a passenger vehicle.

FIG. 8 is a schematic diagram of three electric power tunnels according to the present invention mounted on the bed of a pick-up truck.

FIG. 9 is a schematic diagram of a pair of electric power tunnels (which could be an unlimited series of electric power tunnels) according to the present invention mounted on the top of a trailer truck.

FIG. 10 is a schematic diagram of a pair of electric power tunnels according to the present invention mounted on a motorcycle.

FIG. 11 is a schematic diagram of three electric power tunnels (which could be an unlimited series of electric power tunnels) combined with a battery pak according to the present invention.

### DESCRIPTION OF THE PREFERRED EMBODIMENT

With reference to the drawings, a new and improved electric generator apparatus embodying the principles and concepts of the present invention will be described.

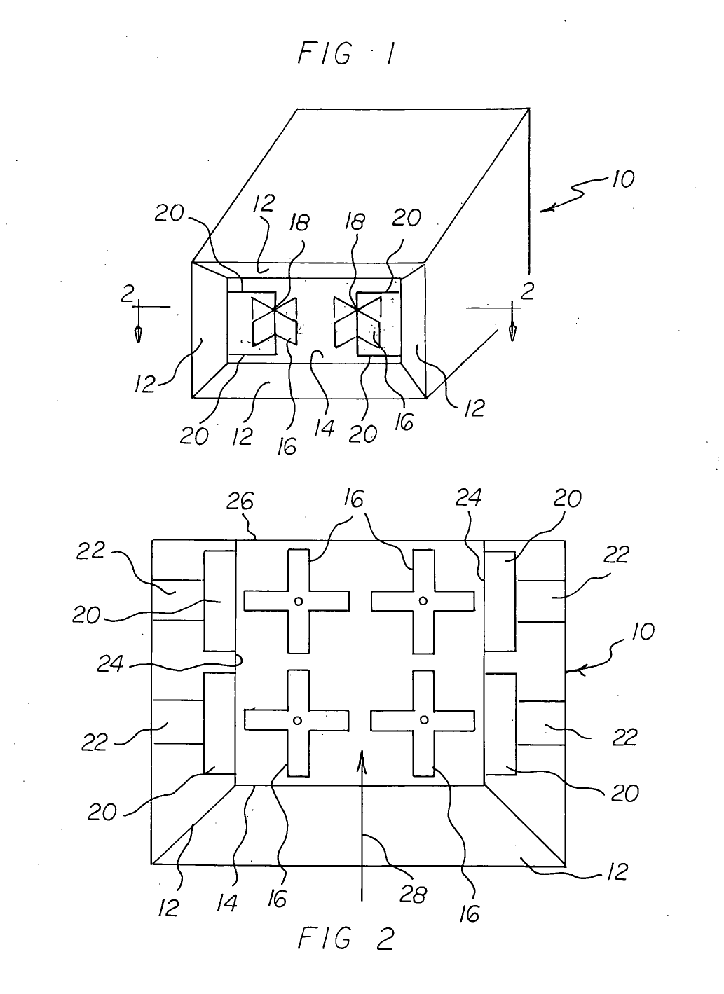

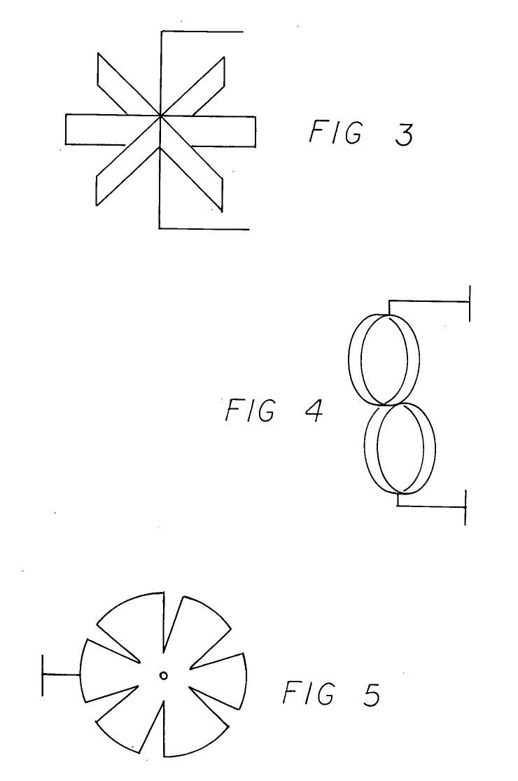

Turning initially to FIGS. 1 and 2, there is shown a preferred embodiment of the electric generator apparatus of the invention in the form of a self-contained unit or module (EPT) generally designated by reference numeral 10. In each of the Figures, reference numerals are shown that correspond to like reference numerals that designate like elements shown in other Figures.

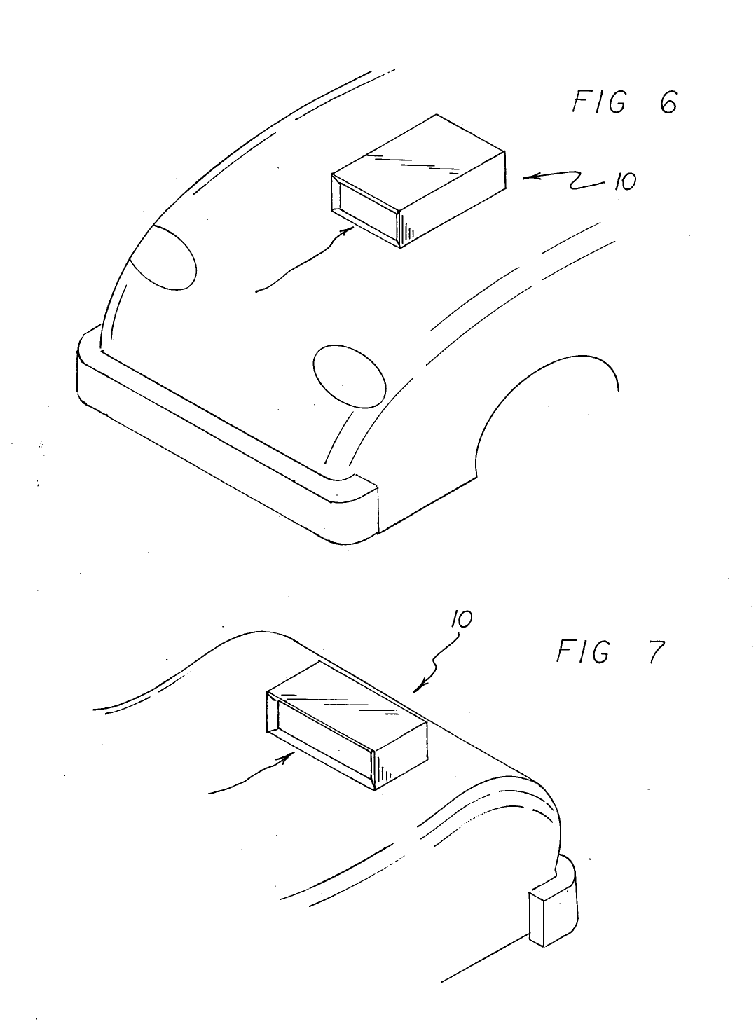

Module or EPT 10 generally is rectangular in overall shape and has a front end characterized by inwardly sloping or converging wall portions 12 sufficient to create a rectangular opening 14 of smaller size than the EPT's front end. Smaller opening 14 is located inside the module axially aft of the latter's front end substantially as depicted. This construction defines a venturi which accelerates the air stream impinging upon the EPT's front end and the stream passes through opening 14 to create a forceful flow of air adapted to impinge upon a set of four impeller assemblies or turbine blade assemblies 16 mounted for rotation inside the module on corresponding shafts 18, respectively. Each shaft 18 is connected through suitable gearing (represented schematically by lines 20) to a corresponding transmission box 20 which, in turn, is connected to a corresponding electric generator 22. The design or configuration of turbine blade assemblies 16 is not critical. As shown in FIGS. 7-9 various well known turbine blade assemblies may be used to carry out the invention. These include, for example: vertical shaft mounted blades (FIG. 5); horizontal shaft mounted blades (FIG. 7); or “eggbeater” style Darrieus blades (FIG. 6). It will be appreciated that the EPT can include various channel or fin arrangements (not shown) for providing clean or non-turbulent air flow to each impeller or turbine assembly.

As best seen in FIG. 2, the interior of module 10 contains walls 24 extending longitudinally through the module to a rear exit opening 26. The walls 24 define a “tunnel” which houses the turbine blade assemblies 16 whereas the transmission boxes 20 and the generators 22 are mounted outside the tunnel, but still repose inside the module. It will be appreciated that air entering the module 10 indicated by arrow 28 initially impinges upon converging walls 12, passes through smaller opening 14, enters the tunnel and thence impinges upon the turbine impeller assemblies 16 before ultimately exiting through the rear exit opening 26. Manifestly, air is caused to flow operatively through each EFT 10 in the direction of arrow 28 when that EFT is fixedly mounted on a vehicle in such a manner that the front end of the EFT faces forwardly as the vehicle travels down the road. As the vehicle moves thusly, the turbine assemblies 16 in the tunnel of the module are caused to rotate in response to air flowing through the tunnel, and electricity is produced by generators 22 for use elsewhere in the vehicle. That electrical energy can be used to drive auxiliary devices in the vehicle or charge a battery in the vehicle as will be explained further below.

As contemplated by this invention, each EPT or module is a self-contained, replaceable unit which may be placed anywhere on a vehicle with its front opening facing in the direction of normal forward travel of the vehicle. The module or modules preferably are mounted in place using conventional affixing means (not shown) which may comprise fasteners, brackets, connect-and-disconnect assemblies or the like, all of which are well known and beyond the scope of this invention.

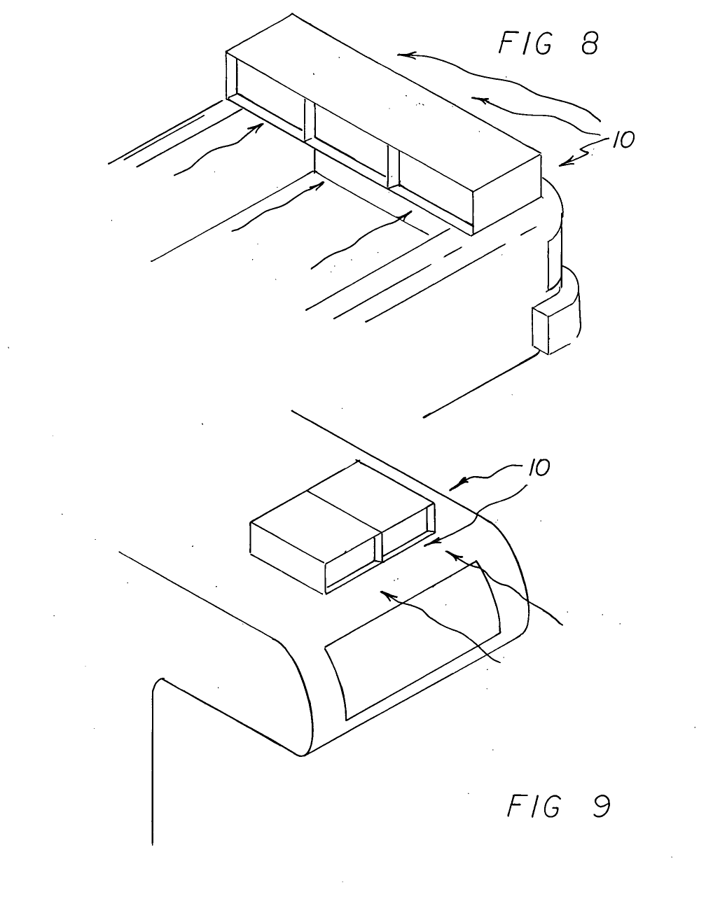

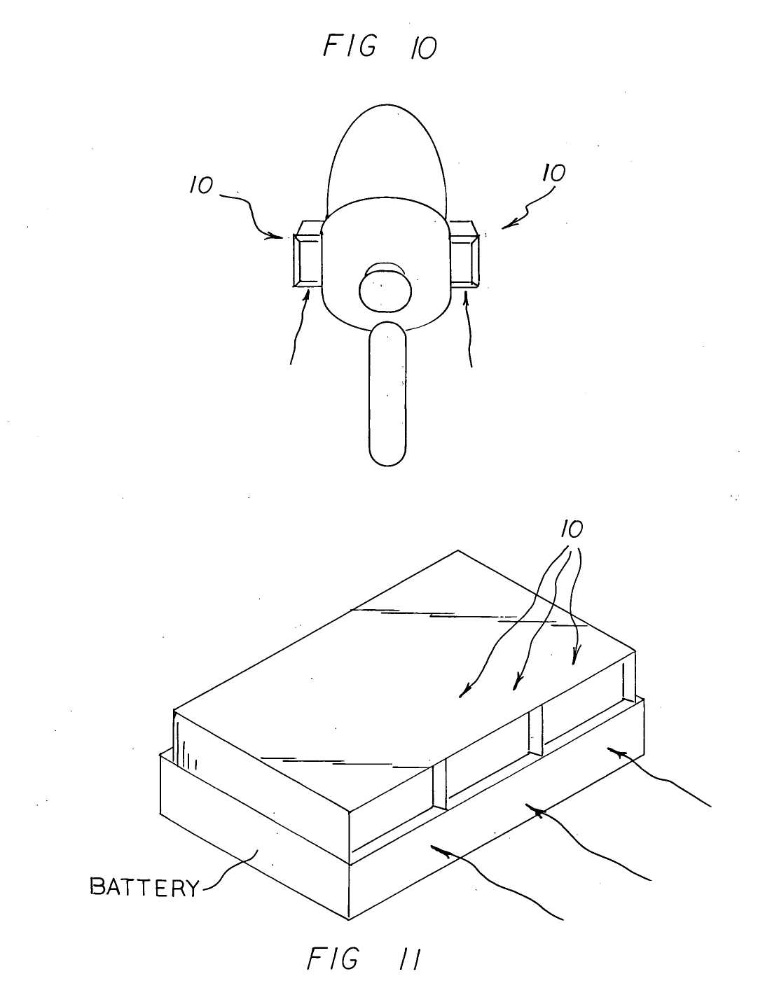

Further, each module or EPT is relatively small in size. To illustrate by way of example without limiting the present invention, a typical module 10 can be 12″ wide by 12″ long by 4″ high. As a result of such relatively small size, the module may be placed, for example, on the front hood of a conventional passenger vehicle much like a conventional carburetor scoop (FIG. 6); on the rear deck or trunk lid of the vehicle either alone or in association with a rear spoiler (FIG. 7); on the bed of a pick-up truck (FIG. 8); on the roof top of a trailer (FIG. 9); or on a motorcycle, such as preferably on the sides of the fuel tank (FIG. 10); or numerous other vehicle types (not depicted). It will be noted that the EPT may be employed singly or in combination with others to form sets (see FIGS. 7-9). Also, each EPT may be provided with its own storage battery to store excess electricity as will be made evident below. Such an arrangement is schematically depicted in FIG. 11 which shows three EPTs mounted on an associated battery pak. This entire assembly, in turn, may be affixed to a vehicle in a suitable location. Future improved and more efficient EPT design will be of a similar configuration to allow a person to replace the obsolete version with the new upgraded version, using the same attachment apparatus to the vehicle.

It will be appreciated that the electrical output of each module 10 comprises useful supplemental electrical power which may be used elsewhere in a moving vehicle to increase efficiency and lower fuel consumption. Thus, suitable conductors (not shown) can be provided to connect each module or EPT 10 to the vehicle's central computer and battery which, in turn, distributes the electricity in such a manner as to power small electrical motors connected to the auxiliary devices in the vehicle such as the air-conditioner, the water-pump, the power steering unit, or even electric motors used for braking. Any excess electrical power produced by the EPT can be stored in an electrical storage device in the vehicle such as a supplemental storage battery, for example. Thus, when used in a conventional vehicle utilizing a gasoline or diesel engine, use of the EPT will permit the alternator or generator to be eliminated, and virtually all of the engine's drive belts and pulleys eliminated as well because substantially all of the auxiliary devices will be powered either directly from the EPT (when the car is moving) or from a storage battery in the vehicle being charged by the EPT.

Similarly, when one or more EPTs is or are used in a “Hybrid” vehicle, the normal generator will be eliminated and small electric motors may be used to power the auxiliary devices. Additionally, the EPT can supply electrical power to the Hybrid's main battery, and auxiliary equipment. A second battery may also be added to a Hybrid vehicle allowing it to operate the vehicle's electrical motor(s) for a longer duration, and at both low and high speeds. This in turn will require a smaller, less gasoline consuming heat engine in the Hybrid vehicle.

Also, when an EPT is used in a pure electric vehicle, the electric motor will receive a constant supply of supplemental electrical power thereby powering the vehicle over a greater range and for longer durations. The fully electric vehicle may still need to have its main battery periodically charged, but less often when an EPT is used in conjunction therewith.

Finally, when an EPT is used with a stand-alone power pak unit, the batteries therein will receive a constant supply of supplemental electric power thereby charging the unit without a gasoline generator or electric outlet. The stand-alone power pak may still need to have its main batteries periodically charged, but less frequently when an EPT is used in conjunction therewith.

From the foregoing, it will be appreciated that the electric power tunnel apparatus of the invention can be used to create a constant supply of electricity, eliminating the need for a gasoline or other fuel motor to perform the function of generating electrical power via a generator or alternator. Rather than using conventional drive belts and associated pulleys to take off power from a gasoline engine to thereby operate the auxiliary devices in a vehicle, use of an EPT according to the invention, in conjunction with small electrical motors connected to such devices, may be employed instead. Thus, by shifting the power source for the vehicle's peripheral devices to the EPT, the required horsepower output of the main gasoline/heat engine may be reduced thereby greatly increasing fuel economy. This will in part be due to the ability to utilize/install a smaller (less displacement) gasoline engine which obtains better gas mileage. Similarly, use of an EPT in a Hybrid or pure electric vehicle will supply a constant stream of supplemental electrical energy to the vehicle's main electric motors and batteries. The Hybrid thus will reduce reliance on its gasoline motor more often. The pure electric vehicle will reduce the frequency and extent of external outlet charges as the vehicle's main electric motor and batteries will utilize the electricity generated by the EPT. Hence, the pure electric vehicle will have greater range (operate longer) and not need to be charged as often.

The components of the electric power tunnel apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved electric power tunnel apparatus that is low in cost, relatively simple in design and operation, and which may advantageously be used to provide a source of supplemental electrical power in a vehicle with minimal alteration to the vehicle structure. With the invention, an electric power tunnel is provided that operates in response to the movement of air resulting from motion of the vehicle. With the invention, an electric power tunnel is provided in the form of an easily replaceable self-contained module that is susceptible of being placed virtually anywhere on a vehicle either alone or in groupings or sets of more than one module. With the invention, an electric power tunnel is provided is in the form of a module having a wind tunnel inlet or venturi for increasing the efficiency of the air flowing therethrough. With the invention, an electric power tunnel is provided in the form of a module having rotating impellers or turbines and a generator for converting the flowing airstream therethrough into electrical current. With the invention, electricity will be managed and controlled by a computer and controller chips. With the invention, an electric power tunnel is provided in the form of a module which may be used to generate electricity on a conventional vehicle so that generator or alternator and substantially all of the usual belts and pulleys that normally power auxiliary equipment may be removed from the vehicle's gasoline or diesel engine. With the invention, an electric power tunnel is provided in the form of a module which may be used on a Hybrid vehicle or on a pure electrical vehicle to charge a battery on such vehicles, or to power auxiliary equipment on such vehicles.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by LETTERS PATENT of the United States is as follows:

1. An electric generator apparatus for a vehicle, comprising:
a self-contained replaceable module adapted to be fixedly mounted in a predetermined location substantially anywhere on said vehicle,
wherein said module comprises an inlet, and a rotatable energy converter mounted in proximity to said inlet inside said module to receive air flowing through said inlet when said module and said vehicle are in motion,
wherein said module further comprises an electrical generator coupled to said rotatable energy converter and operable in response to rotation thereof to generate electricity used by said vehicle thereby enabling the engine in said vehicle to run more efficiently than it would without said module mounted thereon.

2. The apparatus of claim 1 wherein said apparatus further comprises a supplemental battery for storing said generated electricity for subsequent use on said vehicle.

3. The apparatus of claim 2 wherein use of said module on said vehicle permits said vehicle's normal generator or alternator to be eliminated.

4. The apparatus of claim 1 wherein said vehicle is a Hybrid vehicle and use of said module permits said vehicle's normal generator or alternator to be eliminated.

5. The apparatus of claim 1 wherein said vehicle is an electric vehicle and use of said module on said vehicle increases the duration of electric charge on said electric vehicle's main battery.

6. The apparatus of claim 1 wherein said energy converter is a turbine assembly.

7. The apparatus of claim 6 wherein said module is generally rectangular in overall shape and has a front end characterized by inwardly sloping or converging wall portions, said wall portions defining a rectangular opening of smaller size than said module's front end, said opening of smaller size being located inside the module aft of the latter's front end to create a venturi proximal to said turbine assembly.

8. The apparatus of claim 6 wherein said turbine assembly is mounted on a shaft for rotation, said shaft being operatively coupled to an electric generator housed in said module.

9. The apparatus of claim 8 further including a transmission connected between said shaft and said electric generator.

10. The apparatus of claim 6 wherein said turbine assembly is mounted on a shaft for rotation and said shaft is vertically oriented inside said module.

11. The apparatus of claim 6 wherein said turbine assembly is mounted on a shaft for rotation and said shaft is horizontally oriented inside said module.

12. The apparatus of claim 6 wherein said turbine assembly is of the Darrieus blade type.

13. The apparatus of claim 7 wherein said module defines a tunnel communicating at one end with said venturi, said tunnel having an opposed end defining an exit opening, and said turbine assembly being mounted in said tunnel between said venturi and said exit opening.

14. The apparatus of claim 9 wherein said wherein said module defines a tunnel communicating at one end with said venturi, said tunnel having an opposed end defining an exit opening, said turbine assembly being mounted in said tunnel between said venturi and said exit opening, and wherein said generator and said transmission are located outside said tunnel.

15. The apparatus of claim 1, further comprising a computer for controlling the distribution of electricity throughout said vehicle, said computer being operatively coupled to said electrical generator coupled to said rotatable energy converter.
